(19) United States
(12) Patent Application Publication
(10) Pub. No.: US 2026/0278641 A1
(43) Pub. Date: Sep. 17, 2026

(54) Monetized Artificial Intelligence Voice Activated Commands for Interactive Business Promotion

(71) Applicant: Stephen M. Byrd, Upper Marlboro, MD (US)

(72) Inventor: Stephen M. Byrd, Upper Marlboro, MD (US)

(21) Appl. No.: 19/076,711

(22) Filed: Mar. 11, 2025

(51) Int. Cl. G06Q 30/0251; G06Q 30/0241; G06Q 30/0273; H04N 21/422; H04N 21/431; H04N 21/478

(52) U.S. Cl. CPC G06Q 30/0257; G06Q 30/0261; G06Q 30/0273; G06Q 30/0276; H04N 21/42203; H04N 21/42222; H04N 21/4316; H04N 21/47815

(57) ABSTRACT

The present invention relates to a monetized artificial intelligence voice activated commands system for interactive business promotion system. It discloses a voice-based digital assistant system for displaying live business deals, offers or promotions to the customers and empowering businesses for the voice-activated revolution. The monetized artificial intelligence voice activated commands system for interactive business promotion system for displaying live business deals, offers, or promotions to customers is comprised of a multi-prolonged solution, voice-activated commands, smart television integration modules, and API integration modules. The system is designed to enable viewers to speak directly to their smart televisions and their remotes, wherein the voice software is added to all remotes, including universal remotes.

### CROSS REFERENCE TO RELATED APPLICATIONS

The present application is a Continuation-In-Part application of U.S. patent application Ser. No. 16/823,370 filed on 19 Mar. 2020, patent application No. Ser. No. 17/408,858 filed on 23 Aug. 2021, and patent application No. Ser. No. 18/931,125 of 30 Oct. 2024 and entitled “Monetized Voice System and Method for Interactive Business Promotions Based on Artificial Intelligence” which are herein incorporated in their entirety.

### TECHNICAL FIELD

The present invention relates to Artificial Intelligence based informative digital assistant system, more particularly, a monetized artificial intelligence voice activated commands for interactive business promotion to the customers and empowering business for the voice-activated revolution.

### BACKGROUND ART

Voice recognition has gained prominence and use with the rise of artificial intelligence (AI) and intelligent assistants, such as Amazon's Alexa and Apple's Siri. Voice recognition systems let consumers interact with technology simply by speaking to it, enabling hands-free requests, reminders and other simple tasks.

Internet user's behavior is rapidly changing. The world has entered into the era of web 3.0. The conventional modes of gathering information like Internet surfing has gone. People are increasingly relying on the Artificial Intelligence search results especially voice assistants.

These AI virtual assistants process spoken language through advanced features such as speech recognition and natural language processing (NLP). Natural Language Processing (NLP): NLP is the core technology that helps the assistant understand customer requests and convert them into actionable data.

There are some related prior art patents to the present invention. In patent application, bearing application number US20210134263A1, Victor et al. discloses a platform and system for the transcription of electronic online content from mostly visual/text format to an aural format, adapted for being read by an intelligent speaker system. It specifically discloses an automated engine with artificial intelligence and/or machine learning for the transformation of written websites into audio enabled content for use in association with new technology intelligent speakers, for implementing data mining, processing, and summarizing tools.

Another granted patent to Apple Inc., U.S. Pat. No. 9,548,050B2 filed by Thomas et al. teaches about an intelligent automated assistant system that engages with the user in an integrated, conversational manner using natural language dialog, and invokes external services when appropriate to obtain information or perform various actions.

The US patent application number US12067006B2 of 2021 by Soundhound AI IP Holding LLC discloses a machine learning system for digital assistants together with a method of training such a system. The machine learning system is based on an encoder-decoder sequence-to-sequence neural network architecture trained to map input sequence data to output sequence data, where the input sequence data relates to an initial query and the output sequence data represents canonical data representation for the query. However, some interactions and method steps within the system are different from those of the SoundHound AI.

The US patent application number US20220165272A1 of 2017 by Soundhound AI IP Holding LLC discloses a recommendation engine for upselling in restaurant orders. A computer-implemented method is provided to support a food ordering system for food items from a menu of a restaurant using natural language.

None of the above discussed prior arts teaches about informative voice based, AI enabled digital assistants specifically meant for displaying location based live business deals, promotions or offers as per customer interests and preferred geographical locations.

Currently, there is no system in place which allows the businesses to advertise on the responses of the voice assistants. Huge markets are willing to pay for the advertisements like live business deals, job opportunities and promotions within the voice assistants searches.

The market size is huge. There are about 4.2 billion users globally with about 200 million users in the US alone. There is need to develop voice-based digital assistant system for displaying live business deals, offers or promotions to the customers.

### OBJECTS OF THE INVENTION

The main object of the present invention is to provide a voice-based digital assistant system for displaying live business deals, offers or promotions to the customers.

This summary is not an extensive overview of the invention and does not intend to limit the scope beyond what is described and claimed as a summary.

### SUMMARY OF THE INVENTION

Embodiments of the present disclosure may include a system including a data storage populated with a plurality of merchant offers' data records. Embodiments may also include an artificial intelligence-based digital assistant module connected to the data storage over a network interface configured for two-way communication between the artificial intelligence-based digital assistant module and a plurality of computing devices.

The present invention relates to Artificial Intelligence based informative digital assistant system, more particularly, voice-based digital assistant system for displaying live business deals, offers or promotions to the customers and empowering business for the voice-activated revolution.

In one embodiment, the present invention presents a system for the future of advertising. The present invention is a continuation of the pending patent applications Ser. No. 17/408,858 entitled “AI-powered platform designed to transform text into dynamic, interactive voice ads for businesses of all sizes and patent application Ser. No. 18/931,125 of 30 Oct. 2024 and entitled “Monetized Voice System and Method for Interactive Business Promotions Based on Artificial Intelligence”.

In another embodiment, the present invention provides a system which allows the businesses to advertise on the voice assistants and generate revenue from 200 million daily US users and 4.2 billion globally.

In another embodiment, the present invention describes a multi-prolonged solution encompassing various aspects of voice commands and its application.

The system is designed to enable viewers to speak directly to their smart televisions as well as their remotes wherein the Voicee Software will be added to all remotes including Universal Remotes.

### BRIEF DESCRIPTION OF THE DRAWING

The novel features believed to be characteristic of the illustrative embodiments are outlined in the appended claims. The illustrative embodiments, however, as well as a preferred mode of use, further objectives, and descriptions thereof, will best be understood by reference to the following detailed description of one or more illustrative embodiments of the present disclosure when read in conjunction with the accompanying drawings.

FIG. 1 is a block diagram illustrating a monetized artificial intelligence voice activated commands for interactive business promotion based on artificial intelligence, according to some embodiments of the present invention.

FIG. 2 is a block diagram illustrating a monetized artificial intelligence voice activated commands for interactive business promotion system, according to some embodiments of the present invention.

FIG. 3 is a block diagram illustrating a television interaction method of the system, according to some embodiments of the present invention.

### DESCRIPTION OF THE INVENTION

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

In this description, the terms “comprising,” “including,” “containing,” “characterized by,” and grammatical equivalents thereof are inclusive or open-ended terms that do not exclude additional, un-recited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

The singular forms “a,” “an,” and “the” are intended to include the plural forms as well, unless the context clearly indicates otherwise.

The term “and/or” includes any and all combinations of one or more of the associated listed items. As used herein, relational terms, such as “first,” “second,” “top,” “bottom,” “upper,” “lower,” “over,” “under,” etc., are used for clarity and convenience in understanding the disclosure and do not connote or depend on any specific preference, orientation, or order, except where the context clearly indicates otherwise.

In a general embodiment, the present invention relates to Artificial Intelligence App based informative digital assistant system, more particularly, voice-based digital assistant system for displaying live business deals, offers or promotions to the customers and empowering business for the voice-activated revolution.

In one embodiment, the present invention presents a system for the future of advertising. The present invention is a continuation of the pending patent application Ser. No. 17/408,858 entitled “AI-powered platform designed to transform text into dynamic, interactive voice ads for businesses of all sizes.

In another embodiment, the present invention provides a system which allows the businesses to advertise on the voice assistants and generate revenue from 200 million daily US users and 4.2 billion globally.

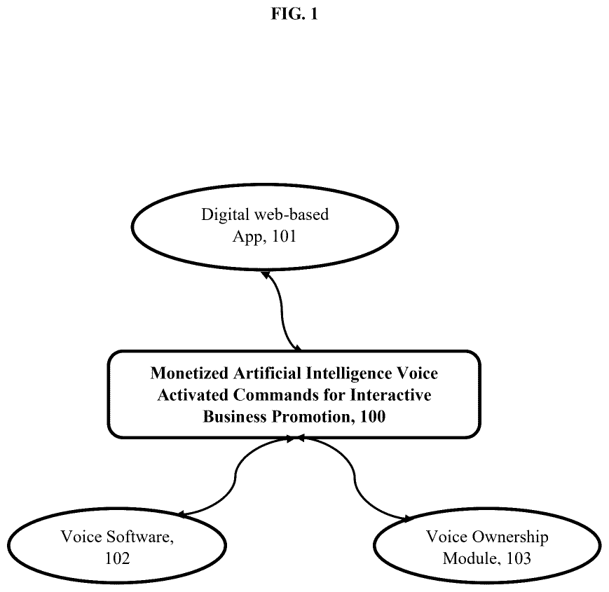

In FIG. 1, the invention describes a monetized voice system 100 for interactive business comprising three interconnected products, namely; a digital web-based App 101, voice software 102, and voice ownership module 103.

The digital web-based App 101 at Voicee. com website is a self-service platform that enables businesses to create text-based ads, convert them to voice in minutes, and choose relevant keywords. Advertisers pay for ad placements based on the number of times they want their ads voiced. When a user invokes a keyword, the corresponding ad is played, allowing for seamless voice-based transactions.

Voice software 102 is the monetization engine behind VoiceeAds. com. This proprietary software can be integrated into existing voice assistants, voice speakers, open AI platforms, and smart glasses, enabling these devices to be monetized. By partnering with Voice, device manufacturers and platform providers can unlock new revenue streams.

Voice ownership module 103 offers companies their own personalized voice assistant for marketing products and services. This solution can be integrated with existing voice assistants, voice speakers, open AI platforms, and smart glasses. Companies can pay a premium to run their ads on these devices, further expanding their reach. The voice software 103 is integrated into various devices, enabling users to ask their smart TV to “find the best pizza deals in my area” and receive voice ads from local restaurants, and use their smartphone or smart eyeglasses to ask “what coffee deals are available near me?” and get targeted ads from nearby cafes.

To illustrate this feature, let's consider a real-world example: Suppose the local Popeyes Chicken restaurant has cooked too much chicken and needs to sell it quickly. With Voicee, the manager can access the system, create or change their ad, and within a couple of minutes, the updated ad will be available to everyone searching for related keywords. Moreover, they can send out a Special Order Alert, notifying customers of a limited-time offer. Embodiments of the present disclosure may include a system including a data storage populated with a plurality of merchant offers' data records.

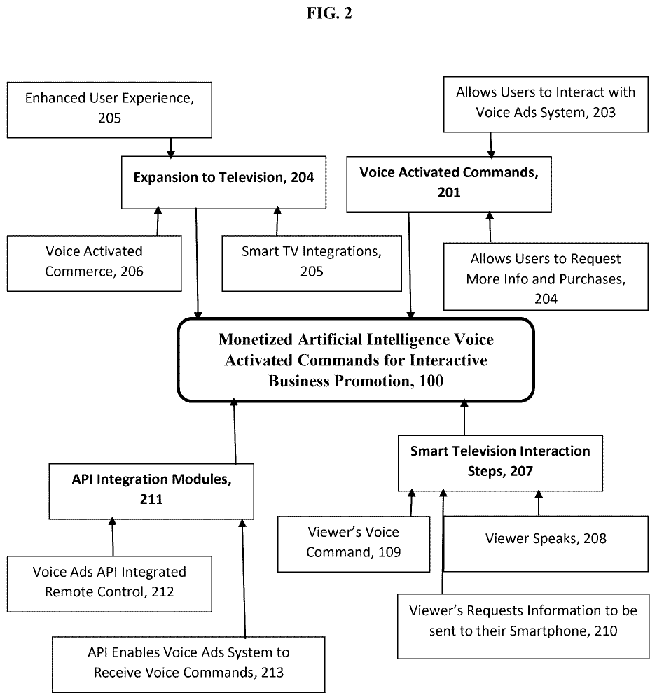

In FIG. 2, the invention illustrates a block diagram illustrating a voice activated commands for interactive business promotion 100 based on artificial intelligence, according to some embodiments of the present invention further comprising a multi-prolonged solution; voice-activated commands 201, smart television integration modules 207, and API integration modules 211. The multi-prolonged solution encompasses various aspects of voice commands and its application.

The smart television integration modules 207 are integrated into voice-advertisements system with remotes and televisions in that the integration of the system is with remote control technology and smart TV platforms, enabling voice-activated commerce and enhanced user experience. The integration enables viewers to speak 208 through a remote or directly to their television or their smartphones 210, requesting more information or initiating a purchase while watching a commercial. It also enables the viewer's voice command 209 to be processed and the commercial is resized to a smaller window on the television, allowing programming to continue in a larger window with the commercial and viewers to request that information be sent to their smartphones 210 or device or complete the purchase directly from the television. In the integration with remotes and televisions, the system describes integration with remote control technology and smart TV platforms, enabling voice-activated commerce and enhanced user experience.

The API integration modules 211 has voice-ads API that is integrated with remote control technology 212, allowing for seamless communication between the ad system and remote controls so as the API integration enables the system to receive voice commands and transmit relevant information to the remote control. The API integration 211 enables voice Ads of the system to receive voice commands 213 and transmit relevant information to the remote control.

The voice-activated commands 201 are designed to allow users to interact with the ad system 203 through remote controls or smart televisions so that the users are able to issue voice commands to request more information or initiate purchases 204.

In another embodiment, FIG. 2 shows the voice-activated commands 201 for expansion of televisions 204 that are crafted to provide smart TV integration 205 in which the ads system is integrated with smart TV platforms, enabling voice-activated commerce 206 and enhanced user experience, the voice-activated commerce 206 enables users to purchase products and services directly through their televisions using voice commands 201, and the voice-activated commerce 206 further comprises a module for enhanced user experience in the ad system that provides personalized recommendations and other relevant content to enhance the user experience 205 where the system Ads provides personalized recommendations.

The voice-based digital assistant system further comprising a monetized voice system, data storage, an artificial intelligence-based digital assistant module, at least a first microphone, geolocation module, and keyword recognition module. The monetized voice system for interactive business promotions based on artificial intelligence. The system further comprises a data storage populated with a plurality of merchant offers' data records.

The artificial intelligence-based digital assistant module connected to the data storage over a network interface configured for two-way communication between the artificial intelligence-based digital assistant module and a plurality of computing devices and may include an interactive graphical user interface configured to receive text input from a user.

The first microphone configured to receive an audio input from the user. The geolocation module configured to generate geolocation data of the user. The keyword recognition module configured to process text-based commands from the user and transcode the text-based commands into voice data. The system is designed to enable viewers to speak 208 directly to their smart televisions as well as their remotes wherein the voice software is added to all remotes including universal remotes.

In another embodiment, the present invention describes a multi-prolonged solution encompassing various aspects of voice commands and its application. Embodiments may also include an artificial intelligence-based digital assistant module connected to the data storage over a network interface configured for two-way communication between the artificial intelligence-based digital assistant module and a plurality of computing devices.

In some embodiments, the artificial intelligence-based digital assistant module may include an interactive graphical user interface configured to receive text input from a user. Embodiments may also include at least a first microphone configured to receive an audio input from the user. Embodiments may also include a geolocation module configured to generate geolocation data of the user. Embodiments may also include a keyword recognition module configured to process text-based commands from the user and transcode the text-based commands into voice data.

In one embodiment, the present invention describes n integration of voice-advertisements system with remotes and televisions. The present disclosure describes the integration of the system with remote control technology and smart TV platforms, enabling voice-activated commerce and enhanced user experience. In another embodiment, the invention teaches an API integration in which the voice-ads API is integrated with remote control technology, allowing for seamless communication between the ad system and remote controls. The API integration enables the system to receive voice commands and transmit relevant information to the remote control.

In another embodiment, the present invention describes a voice-activated commands developed to allow users to interact with the ad system through remote controls or smart televisions. Users are able to issue voice commands to request more information or initiate purchases.

In another embodiment, the present invention provides voice-activated commands for expansion of televisions by providing smart TV integration in which the ads system is integrated with smart TV platforms, enabling voice-activated commerce and enhanced user experience. The voice-activated commerce 206 enables users to purchase products and services directly through their televisions using voice commands. There is also enhanced user experience 205 in the ad system provides personalized recommendations.

In another embodiment, the present invention provides a system that is personalized recommendations, and other relevant content to enhance the user experience. The system is designed to enable viewers to speak directly to their smart televisions as well as their remotes wherein the voice software will be added to all remotes including universal remotes.

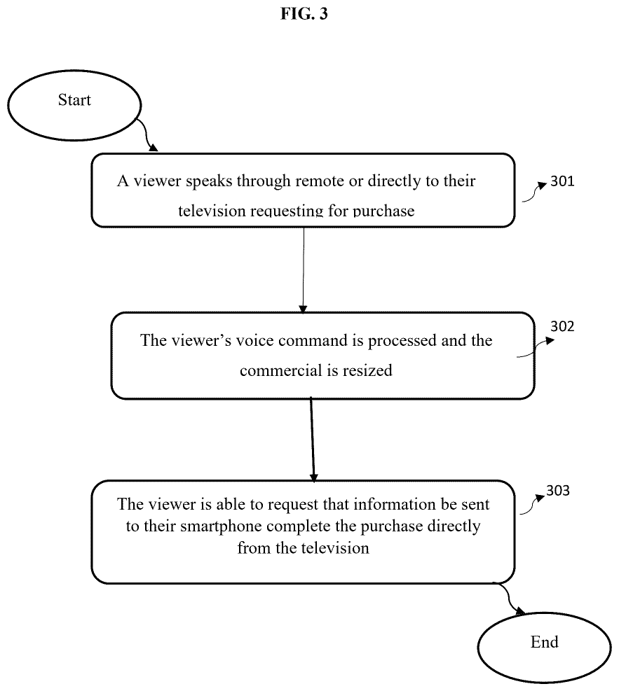

In FIG. 3, the present invention provides the following steps a viewer speaks through remote or directly to their television, requesting more information or initiating a purchase while watching a commercial at step 301, the viewer's voice command is processed. The commercial is resized to a smaller window on the television allowing programming to continue in a larger window at step 302. Viewer is able to request that information be sent to their smartphone or device or complete the purchase directly from the television at step 303.

### Key Benefits

The system has unparalleled Reach: The platform reaches millions of users across leading voice assistants and devices. Targeted Advertising: Advertisers can choose specific keywords to target users who are actively searching for products or services. Cost-Effective: Pay-for-performance model eliminates costly bidding wars. Measurable Results: Advanced analytics provide incredible insights, empowering businesses to make data-driven decisions and optimize their marketing strategies.

The system offers advanced analytics, providing detailed insights into user engagement, ad performance, conversion rates, and customer behavior. Voice reviews, enabling users to request reviews and testimonials from other customers, fostering trust and driving purchasing decisions. The system is poised to transform the voice marketing landscape. By partnering with us, you can unlock new revenue streams, enhance your marketing capabilities, and stay ahead of the competition.

All voice products offer an advanced analytics, providing detailed insights into user engagement, ad performance, conversion rates, and customer behavior, and voice reviews, enabling users to request reviews and testimonials from other customers, fostering trust and driving purchasing decisions.

Further, the voice app is poised to transform the voice marketing landscape. By partnering with us, you can unlock new revenue streams, enhance your marketing capabilities, and stay ahead of the competition. The universal use of voice a monetized voice advertising assistant and software. Voice Ads has all ads/deals and jobs with coupon code and resume submission. Voice news, press deals with all breaking news stories for news publishers can post these stories. Voice App is for television or car radios where shoppers can buy products directly through voice from television, radio and online commercial.

All search engines companies can purchase my software to integrate into their voice assistant speakers such as Siri, Alexa, Google, Microsoft, Samsung Bixby etc. Any businesses can buy or partner with Voice Ads and have their own monetized voice marketing assistant. Most have a website or app now they should have their own voice assistant.

Newspapers and Magazine owners & publishers can purchase their own complete voice assistant with the integrated monetized voice marketing assistant.

### Advantages

The voice assistant platform will empower newspapers and magazines to offer voice-enabled news delivery, keeping readers informed on-the-go; advertisers can self-serve ad placement on chosen stories, and Unmatched affordability, reach engaged audience on popular voice assistants.

### Key Benefits Include

Unparalleled reach: voice's platform reaches millions of users across leading voice assistants and devices, targeted advertising: advertisers can choose specific keywords to target users who are actively searching for products or services, cost-effective: pay-for-performance model eliminates costly bidding wars, measurable results: advanced analytics provide incredible insights, empowering businesses to make data-driven decisions and optimize their marketing strategies, and incredible analytics and voice reviews.

The voice assistant platform will unlock the power of the system to boost customer engagement with personalized voice interactions, amplify brand awareness through seamless omni-channel marketing, and drive sales and revenue growth with AI-powered customer insights, enhance customer experience with 24/7 voice support.

What sets voice system own apart is that it is a customizable and scalable solution tailored to your business needs, seamless integration with existing systems and platforms, has advanced analytics and insights for data-driven decision-making, and has a dedicated support team ensuring seamless activation and ongoing success.

This level of flexibility and responsiveness is unprecedented in the advertising industry, and we believe it has the potential to revolutionize the way businesses connect with their customers.

Users can then complete orders seamlessly through voice commands, receive detailed product descriptions, put a rain check on out-of-stock items and receive alerts when they're available, and ask for reviews to be voiced, providing social proof and enhancing purchasing decisions.

While the invention has been described with reference to numerous specific sensors, one of ordinary knowledge in the field will recognize that the invention can be embodied in other specific forms without departing from the spirit of the invention. Specific operations may not be performed in one continuous series of operations, and different specific operations may be performed in different embodiments.

Furthermore, the processes or methods could be implemented using several sub-processes, or as part of a larger macro process. Thus, one of ordinary knowledge in the field would understand that the invention is not to be limited by the foregoing illustrative details, but rather is to be defined by the appended claims.

### INDUSTRIAL APPLICATION

The present invention relates to artificial intelligence based informative digital assistant system. It avails a monetized artificial intelligence voice activated commands for interactive business promotion system, according to some embodiments of the present invention. It enables customers and empowering business for the voice-activated revolution. The system and software will unlock voice assistant integration for all platforms, targeting a global audience of over a billion daily users. It will empower on-the-go consumers with instant, screen free information. Voice's platform reaches millions of users across leading voice assistants and devices. Advertisers can choose specific keywords to target users who are actively searching for products or services. Pay-for-performance model eliminates costly bidding wars. It has measurable results in that it comprises advanced analytics provide incredible insights, empowering businesses to make data-driven decisions and optimize their marketing strategies.

1. A monetized artificial intelligence voice activated commands system for interactive business promotion to the customers, comprising
a data storage;
at least one computing device coupled to the data storage over a network interface; and
three interconnected products implemented on the at least one computing device, including:
a digital web-based app configured as a self-service platform that enables businesses to create text-based ads, convert the text-based ads to voice, and choose relevant keywords, wherein advertisers pay for ad placements based on the number of times they want their ads voiced, and when a user invokes a keyword, a corresponding ad is played, allowing for seamless voice-based transactions;
a voice software; and
a voice ownership module.

2. (canceled)

3. The monetized artificial intelligence voice activated commands system according to claim 1, wherein the voice software is the monetization engine behind the system website, wherein the said proprietary software can be integrated into existing voice assistants, voice speakers, open AI platforms, and smart glasses, enabling these devices to be monetized and by using the device manufacturers and platform providers can unlock new revenue streams.

4. The monetized artificial intelligence voice activated commands system according to claim 1, wherein the voice ownership module offers companies their own personalized voice assistant for marketing products and services in that the solution can be integrated with existing voice assistants, voice speakers, open AI platforms, and smart glasses and companies can pay a premium to run their ads on these devices, further expanding their reach.

5. The monetized artificial intelligence voice activated commands system according to claim 4, wherein the voice software is integrated into various devices, enabling users to:
ask their smart TV to “find the best pizza deals in my area” and receive voice ads from local restaurants, and
use their smartphone or smart eyeglasses to ask “what coffee deals are available near me?” and get targeted ads from nearby cafes.

6. A monetized artificial intelligence voice activated commands system for interactive business promotion to the customers, comprising:
a data storage;
at least one computing device coupled to the data storage over a network interface;
a digital web-based app, a voice software, and a voice ownership module implemented on the at least one computing device;
a multi-prolonged solution;
voice-activated commands;
smart television integration modules; and
API integration modules.

7. The monetized artificial intelligence voice activated commands system according to claim 6, wherein the multi-prolonged solution encompasses various aspects of voice commands and its application.

8. The monetized artificial intelligence voice activated commands system according to claim 6, wherein the smart television integration module steps are integrated into the voice-advertisements system with remotes and televisions in that the integration of the system is with remote control technology and smart TV platforms, enabling: voice-activated commerce and enhanced user experience to enable viewers to speak through a remote or directly to their television, requesting more information or initiating a purchase while watching a commercial; viewers to speak through a remote or directly to their television or their smartphones, requesting more information or initiating a purchase while watching a commercial. It also enables the viewer's voice command to be processed and the commercial is resized to a smaller window on the television, allowing programming to continue in a larger window, and viewers to request that information be sent to their smartphones or device or complete the purchase directly from the television.

9. The monetized artificial intelligence voice activated commands system according to claim 6, wherein the API integration has voice-ads API that is integrated with remote control technology, allowing for seamless communication between the ad system and remote controls so as the API integration enables the system to receive voice commands and transmit relevant information to the remote control.

10. The monetized artificial intelligence voice activated commands system according to claim 6, wherein the voice-activated commands are designed to allow users to interact with the ad system through remote controls or smart televisions so that the users are able to issue voice commands to request more information or initiate purchases, wherein: the voice-activated commands for expansion of televisions are crafted to provide smart TV integration in which the ads system is integrated with smart TV platforms, enabling voice-activated commerce and enhanced user experience where the system Ads provides personalized recommendations; the voice-activated commerce enables users to purchase products and services directly through their televisions using voice commands, and the voice-activated commerce further comprises a module for enhanced user experience in the ad system that provides personalized recommendations and other relevant content to enhance the user experience.

11. The monetized artificial intelligence voice activated commands system according to claim 6, further comprising: a monetized voice system; a data storage; an artificial intelligence-based digital assistant module; at least a first microphone; a geolocation module, and a keyword recognition module.

12. The monetized artificial intelligence voice activated commands system according to claim 11, wherein the monetized voice system for interactive business promotions based on artificial intelligence.

13. The monetized artificial intelligence voice activated commands system according to claim 10, wherein the system further comprises a data storage populated with a plurality of merchant offers' data records.

14. The monetized artificial intelligence voice activated commands system according to claim 10, wherein the artificial intelligence-based digital assistant module connected to the data storage over a network interface configured for two-way communication between the artificial intelligence-based digital assistant module and a plurality of computing devices and may include an interactive graphical user interface configured to receive text input from a user.

15. The monetized artificial intelligence voice activated commands system according to claim 11, wherein the first microphone configured to receive an audio input from the user.

16. The monetized artificial intelligence voice activated commands system according to claim 11, wherein the geolocation module configured to generate geolocation data of the user.

17. The monetized artificial intelligence voice activated commands system according to claim 11, wherein the keyword recognition module configured to process text-based commands from the user and transcode the text-based commands into voice data.

18. The monetized artificial intelligence voice activated commands system according to claim 11, wherein the system is designed to enable viewers to speak directly to their smart televisions as well as their remotes wherein the Voice Software is added to all remotes including Universal Remotes.

19. A method of providing a monetized artificial intelligence voice activated commands system, comprising a system having at least one computing device, a data storage coupled to the at least one computing device over a network interface, at least a first microphone, a geolocation module, and an artificial intelligence-based digital assistant module executed on the at least one computing device, the method further comprising the following television interaction steps:
a. a viewer speaks through remote or directly to their television, requesting more information or initiating a purchase while watching a commercial, the viewer's voice being received by the at least a first microphone;
b. the viewer's voice command is processed by the artificial intelligence-based digital assistant module, and the commercial is resized to a smaller window on the television allowing programming to continue in a larger window;
c. the viewer is able to request that information be sent to their smartphone or device or complete the purchase directly from the television; and
d. the artificial intelligence-based digital assistant module retrieving, from the data storage populated with a plurality of merchant offers' data records, at least one merchant offer relevant to the viewer's voice command based on geolocation data of the viewer generated by the geolocation module.
